(19) United States
(12) Patent Application Publication
(10) Pub. No.: US 2004/0080899 A1
(43) Pub. Date: Apr. 29, 2004

(54) Computer system including a function-expanding pad and a function-expanding pad connecting unit

(75) Inventors: David Wayne Hill, Cary, NC (US); John Peter Karidis, Ossining, NY (US); Tomoyuki Takahashi, Fujisawa-shi (JP); Kazuhiko Yamazaki, Hiratuski-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/282,865

(22) Filed: Oct. 29, 2002

(30) Foreign Application Priority Data
Oct. 29, 2002 (JP) 2001-331505

(51) Int. Cl. G06F 1/16

(52) U.S. Cl. 361/680

(57) ABSTRACT

A notebook PC is provided with an expansive ten-key pad as a function-expanding pad which can be set to or removed from an accepting portion formed adjacently to a keyboard of a body portion. The notebook PC is also provided with a PDA cradle pad as a function-expanding pad which can be set to or removed from a tray to be taken out from a side portion of the PC. The expansive ten-key pad and the PDA cradle pad are provided with a connection terminal common to the body portion and moreover, a common connection terminal is provided in the accepting portion and the tray. It is possible to change the setting positions of the expansive ten-key pad and the PDA cradle pad which are function-expanding pads in accordance with a user's desires. It is also possible to utilize other funciton-expanding pads with the accepting portions to provide many other types of functions on the PC.

### FIELD OF THE INVENTION

The present invention relates to a computer system or the like whose operability is improved for a user by the provision of a funtion-expanding pad and associated connecting unit for use with a Personal Digital Assistant (PDA) or other function-expanding units.

### BACKGROUND OF THE INVENTION

A computer system such as a PC (Personal Computer) has been used so far in various places including workshops and homes. Types of widely-used computer systems include a desk-top PC used by being almost fixed to a predetermined place such as a desk, a notebook PC comparatively compactly designed by considering portability, and a PDA (Personal Digital Assistant).

These computer systems are generally provided with input devices for a user use in order to input data. These input devices include a keyboard provided with keys for inputting characters and numerals, a movable mouse for pointing to a specific portion on a display screen, a touch panel provided with a pressure-sensitive plate for inputting a handwritten character or illustration, and a scanner capable of scanning an illustration or a photo and capturing it as data.

A desk-top PC uses a keyboard provided with alphabetical-character keys and a ten-key pad for inputting numerals provided adjacently to the keyboard and a mouse. Moreover, it is possible to connect a touch panel and a scanner together with the keyboard and mouse. Thus, in the case of a desk-top PC, it is possible to simultaneously connect and use various input devices in accordance with the request of a user.

However, in the case of compact computer systems such as notebook PCs and PDAs which have been widely used in recent years, the number of usable input devices is restricted. These compact computer systems are frequently moved and used at various places. For example, they may be used at an outing destination of a user or in a traffic means up to the outing destination. Therefore, these compact computer systems are constituted as being as compact and lightweight as possible.

For example, in the case of a notebook PC, an area is restricted on which a keyboard can be set because it is compact and lightweight and therefore, a keyboard having no ten-key pad, that is, having only character keys is generally used for the notebook PC. Therefore, a user operating the notebook PC must use keys provided in character keys in order to input numerals and thus, it takes a lot of time to input numerals. Moreover, in the case of a notebook PC, a pointing stick or a pointing touch pad embedded between character keys of the keyboard is used instead of a mouse which needs a predetermined area in which to operate. However, because the pointing stick or pointing touch pad is very small, it is difficult to completely use it unless a user is skillful with his fingers.

Thus, in the case of a compact computer system such as a notebook PC, because the number of input devices is restricted, a user has to withstand inconvenience in inputting data.

On the other hand, it is possible to use input devices such as a mouse, touch panel, and scanner or the like by connecting them to a compact computer system such as a notebook PC or PDA. However, it is inconvenient to carry these input device with a computer system and it is impossible to use them when there is not any place for setting them at a moving destination. Thus, in the case of a compact computer system, means for inputting data is restricted.

The present invention is achieved to solve the above technical problems and its main object is to provide a computer system superior in operability for a user by allowing a user to selectively add a data pad and/or a mouse to the system to improve the available data input options.

### SUMMARY OF THE INVENTION

To attain the above object, a computer system of the present invention uses a computer system provided with a housing to or from which a plurality of function-expanding pads can be set or removed, in which the housing includes an input portion provided with keys for inputting characters, a mounting portion capable of removably mounting the function-expanding pads adjacently to the input portion, and a tray taken out from the housing and capable of removably mounting the function-expanding pads. This computer system can connect a plurality of function-expanding pads desired by a user.

The tray of this computer system can be provided with an interface for transceiving signals by connecting function-expanding pads mounted in the tray. Moreover, the mounting portion and tray can flexibly mount a plurality of types of function-expanding pads having a common connective portion.

Furthermore, a computer system of the present invention is a computer system whose functions are expanded by connecting function-expanding pads, comprising a plurality of mounting portions capable of mounting function-expanding pads constituted by input devices for inputting data to a system and a connective portion making it possible to transfer data to and from a system by mounting function-expanding pads provided for a plurality of mounting portions.

In this case, at least one of the mounting portions is a tray to be taken out from a computer system so that it can be housed and the tray can be housed in the computer system while mounting the function-expanding pads. Moreover, it is allowed that at least one of the mounting portions is set to a position facing a user when operating the computer system.

Furthermore, a computer system of the present invention is a computer system provided with a housing portion capable of connecting with function-expanding pads, comprising a function-expanding-pad tray protruding from the side portion of the housing portion in the transverse direction and capable of housing function-expanding pads and an interface for transfer data to and from the function-expanding pads at contact faces with the function-expanding pads mounted on the tray, in which the tray can be housed in the housing portion while mounting the function-expanding pads. In this case, the interface is connected by a USB.

Furthermore, a computer system of the present invention is a computer system provided with a mouse, comprising a housing provided with a system, a tray which can be taken out from the housing, a mouse to be housed in the tray, and a signal-transmitting portion for transmitting a signal generated by the mouse taken out of the tray to the system.

In this case, the signal-transmitting portion is a cord for connecting the tray with the mouse and the tray can be provided with a cord-housing portion for housing the cord.

Moreover, a computer system of the present invention is a computer system whose functions can be expanded by connecting function-expanding pads, comprising a housing provided with a system and a function-expanding-pad-connecting unit housed in the housing and connected with the system, in which the function-expanding-pad-connecting unit is provided with a tray capable of removably mounting the function-expanding pads and a case for holding the tray so that the tray can be taken out from the housing. The function-expanding-pad-connecting unit can be housed in the case while the tray mounts the function-expanding pads.

In this case, it is also possible to recognize the present invention as a function-expanding pad. The function-expanding pad is a function-expanding pad constituted so as to be able to connect with a computer system and expand functions of the computer system, comprising a body portion which can be mounted on a mounting portion provided for the computer system and a tray provided for the computer system so that the tray can be taken out and a connective portion provided for a face contacting the mounting portion or tray to transmit a signal which can be input to the computer system.

The function-expanding pad functions as an expansive ten-key pad, a PDA cradle pad, a mouse cradle, or a touch-panel pad.

On the other hand, it is possible to recognize the present invention as a mouse cradle. The mouse cradle can be connected to a computer system, comprising a housing portion for housing a mouse, a cord extending from the mouse, and a reel for winding the cord around the reel. The mouse cradle can be connected to a computer system as a function-expanding pad. Furthermore, the mouse cradle can be housed in a computer system while housing a mouse in a housing portion.

Furthermore, the present invention can be recognized as a function-expanding-pad-connecting unit. The function-expanding-pad-connecting unit is a function-expanding-pad-connecting unit housed in the body portion of a computer system to connect function-expanding pads, comprising a tray capable of removably mounting function-expanding pads and a case for holding the tray so as to be taken out.

For example, a computer system uses a notebook computer system and function-expanding pads can be housed in the side portion of the notebook computer system.

### BRIEF DESCRIPTION OF THE DRAWINGS

Hereafter, the present invention will be described in detail in accordance with the embodiment(s) shown in the accompanying drawings, in which:

FIG. 1 is a general perspective view of a notebook PC;

FIG. 2 is a general perspective view of the notebook PC shown in FIG. 1 when a tray is housed in the notebook PC;

FIG. 3 is a general perspective view of the notebook PC shown in FIG. 1, showing a state when an expansive ten-key pad and a PDA cradle pad serving as function-expanding pads are removed;

FIG. 4 is a perspective view for explaining a unit provided with a tray;

FIG. 5 is a perspective view showing an expansive ten-key pad that is one of the function-expanding pads;

FIG. 6A is a perspective view showing a PDA cradle pad which is one of function-expanding pads and FIG. 6B is a perspective view showing a PDA to be set to a PDA cradle pad;

FIG. 7 is a perspective view showing another function-expanding pad;

FIG. 8 is a perspective view showing a notebook PC connecting with still another function-expanding pad; and

FIG. 9 is a perspective view showing a keyboard for accepting function-expanding pads.

### DETAILED DESCRIPTION OF THE INVENTION

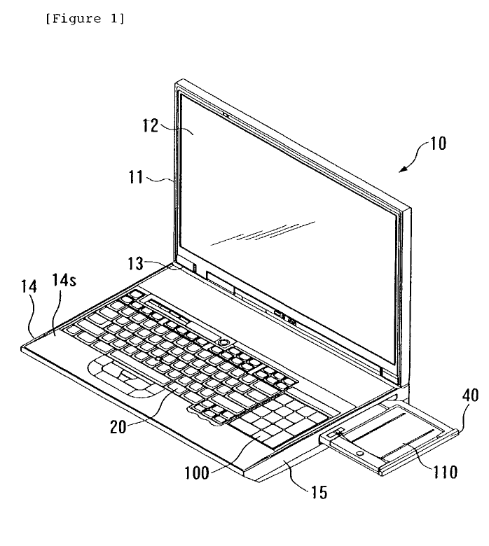

A notebook PC (computer system) 10 shown in FIG. 1 has a body portion (housing portion) 14 provided with input devices including a keyboard (input portion) 20 and a display portion 11 provided with a display screen 12. Moreover, the body portion 14 is rotatably connected with the display portion 11 through a hinge 13. When the notebook PC 10 is not operated, it can be folded by rotating the hinge 13 and superimposing the display portion 11 on the body portion 14 so as to be faced each other.

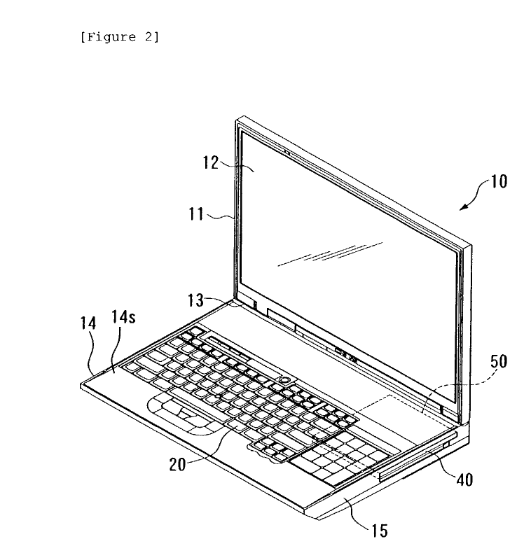

The body portion 14 of the notebook PC 10 is provided with the keyboard 20 on which keys for inputting alphabetical characters are arranged. Moreover, the body portion 14 is provided with an expansive ten-key pad 100 just next to the keyboard 20 as a removable function-extending pad. The expansive ten-key pad 100 has ten keys arranged to input numerals. Moreover, in the case of the body portion 14, a PDA cradle pad 110 is provided on a tray 40 protruding from a side portion 15 as a removable function-expanding pad. As shown in FIG. 2, the tray 40 can be housed in the body portion 14 of the notebook PC 10. Moreover, though details are not illustrated, a CPU, a hard disk, a memory, and a battery are housed in the body portion 14.

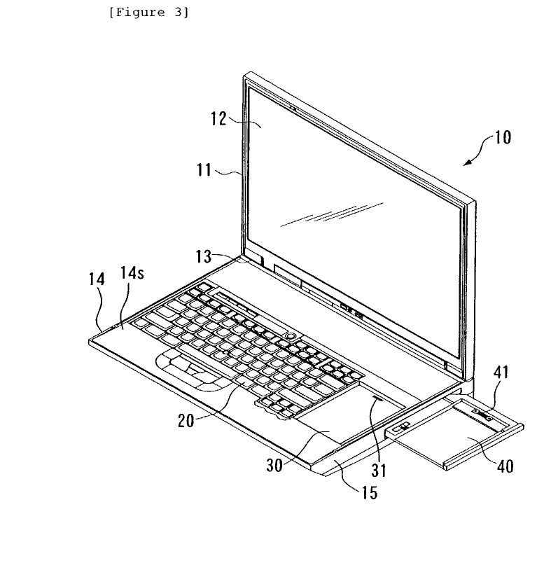

As shown in FIG. 3, at the time of removing the expansive ten-key pad 100 connected to the upper face 14s of the notebook PC 10 shown in FIG. 1, a concave accepting portion (mounting portion) 30 capable of accepting a function-expanding pad is exposed on the upper face 14s of the body portion 14 of the notebook PC 10. A USB (Universal Serial Bus)-connecting terminal (interface or connective portion) 31 for transceiving data by connecting with an accepted function-expanding pad is provided in the accepting portion 30. It is to be understood that the USB connecting terminal 31 could be replaced by a connecting terminal complying with any known or standard method or technology for exchanging information. This is true throughout the present application where USB connections are discussed or disclosed.

Similarly, at the time of removing the PDA cradle pad 110 connected to the tray 40 protruding from the side portion 15 of the notebook PC 10 shown in FIG. 1, the tray 40 capable of accepting a function-expanding pad such as the PDA cradle pad 110 is exposed as shown in FIG. 3. As shown in FIG. 2, the tray 40 is housed in a unit 50 (function-expanding-pad-connecting unit) provided for the notebook PC 10.

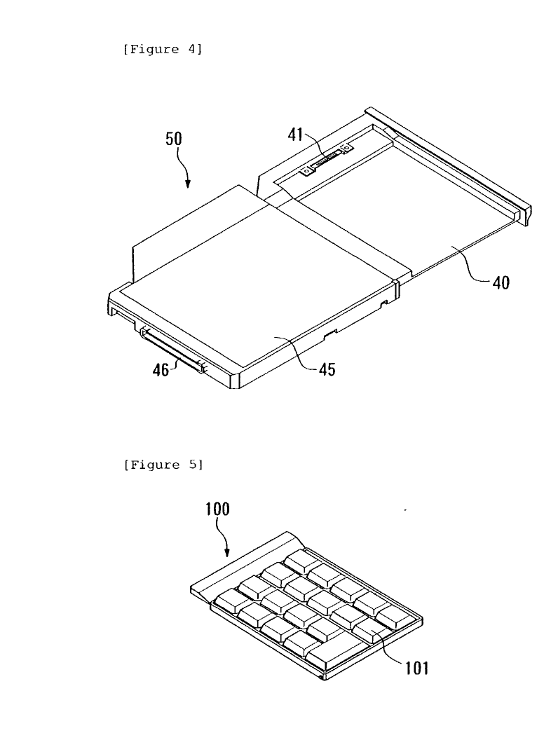

As shown in FIG. 4, the unit 50 introduced into the notebook PC 10 is provided with a case 45 and the tray 40 connected so that it can be taken out from the case 45. As shown in FIG. 2, the case 45 can be housed in the body portion 14 so as to be able to take out the tray 40 from the side portion 15 of the notebook PC 10. Moreover, the case 45 is provided with a connector 46. When the connector 46 is connected with a path in the body portion 14, it is possible to transceive data between a function-expanding pad connected to the tray 40 and the CPU or memory of the body portion 14.

The tray 40 includes a USB-connecting terminal (interface or connective portion) 41 for transceiving data by connecting an accepted function-expanding pad. The tray 40 has a shape substantially the same as the accepting portion 30 provided for the body portion 14 of the notebook PC 10. Moreover, the USB-connecting terminal 41 of the tray 40 has substantially the shape same as the USB-connecting terminal 31 of the accepting portion 30 and is set in substantially the same position in the tray 40 and accepting portion 30. Therefore, a function-expanding pad capable of connecting with the accepting portion 30 can also accept the tray 40.

As shown in FIG. 5, ten keys are arranged on the surface 101 of the expansive ten-key pad 100 removed from the accepting portion 30 of the body portion 14. The expansive ten-key pad 100 has a not-illustrated USB-connecting terminal at the back opposite to the surface 101.

The ten-key pad 100 can be used by connecting the USB-connecting terminal of the expansive ten-key pad 100 with the USB-connecting terminal 31 of the accepting portion 30 of the notebook PC 10. In this case, the notebook PC 10 automatically recognizes that the expansive ten-key pad 100 is connected and the setting necessary for expansion of functions is performed in the notebook PC 10.

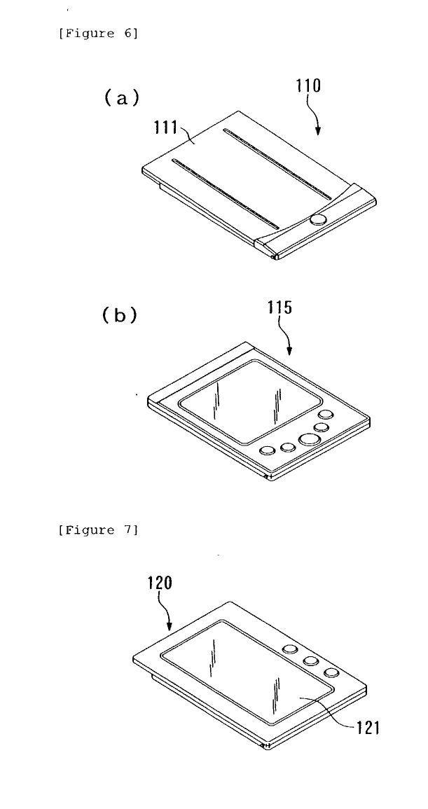

As shown in FIGS. 6a and 6b, the PDA cradle pad 110 removed from the tray 40 of the body portion 14 has a PDA accepting portion 111 on which a PDA 115 can be set and a not-illustrated USB-connecting terminal at the back opposite to the PDA accepting portion 111. When connecting the PDA cradle pad 110 to the tray 40, the USB-connecting terminal of the PDA cradle pad 110 is connected with the USB-connecting terminal 41 of the tray 40 of the notebook PC 10. Then, the PDA 115 set on the PDA accepting portion 111 can transfer data to and from the notebook PC 10 and moreover the notebook PC 10 can supply power to the PDA 115 through the PDA cradle pad 110.

As described above, the notebook PC 10 of this embodiment is provided with the expansive ten-key pad 100 directly connected to the body portion 14 and the PDA cradle pad 110 which can be housed in the body portion 14. Therefore, it is possible to connect a plurality of devices to the notebook PC 10 without increasing the volume of the body portion 14 of the notebook PC 10.

Moreover, in the case of the notebook PC 10, the tray 40 and accepting portion 30 have the same configuration. Therefore, in FIG. 1, the expansive ten-key pad 100 is connected to the accepting portion 30 of the body portion 14 and the PDA cradle pad 110 is connected to the tray 40. However, it is also possible to connect the PDA cradle pad 110 to the accepting portion 30 and the expansive ten-key pad 100 to the tray 40. Therefore, a user can arrange various input devices so that his operability is improved.

Moreover, to carry the notebook PC 10, a user can carry the expansive ten-key pad 100 and PDA cradle pad 110 only when they are necessary. Therefore, when these function-expanding pads are unnecessary, it is possible to decrease the notebook PC 10 to be carried in weight by removing the pads from the PC 10. Moreover, when carrying the expansive ten-key pad 100 and PDA cradle pad 110 without connecting them into the notebook PC 10, it is easy to carry them because they are compact and lightweight.

It is possible to design the unit 50 of the above embodiment into a shape which can be set to a portion of a conventional notebook PC to which a device such as a CD-ROM, CD-R, or DVD-ROM is currently set instead of the device. In this case, the above mentioned is convenient for a user because it may be possible to introduce the unit 50 into a conventional notebook PC by a user. Moreover, it is possible to design the unit 50 so that the tray 40 connected to the PDA cradle pad 110 can be housed in the case 45 while the PDA 115 is connected onto the PDA cradle pad 110.

It is also possible to connect not only the expansive ten-key pad 100 and PDA cradle pad 110 but also other function-expanding pads having a USB-connecting terminal to the accepting portion 30 of the body portion 14 or the tray 40 of the above-described notebook PC 10. Other function-expanding pad that can be connected to the accepting portion 30 and tray 40 will be described below in accordance with a specific example.

The touch-panel pad (function-expanding pad) 120 shown in FIG. 7 is provided with a pressure-sensitive screen 121 and the back of the touch-panel pad 120 opposite to the face on which the screen 121 is set is provided with a not-illustrated USB-connecting terminal. Therefore, the touch-panel pad 120 can be connected into the accepting portion 30 of the body portion 14 or the tray 40 of the notebook PC 10.

In the case of the touch-panel pad 120 shown in FIG. 7, when a finger or a dedicated pen contacts the screen 121, a pressure-sensitive sensor set below the screen 121 can recognize an input character or image. Moreover, the touch-panel pad 120 can be used for certification of a sign. Certification of a sign denotes a system for security for user certification in accordance with the shape of the signature of a user put on the screen 121, pen sequence, pen speed, pen pressure, and spatial movement of a pen. By using the system, it is possible to prevent the notebook PC 10 connecting with the touch-panel pad 120 from being used by persons other than a previously-designated user.

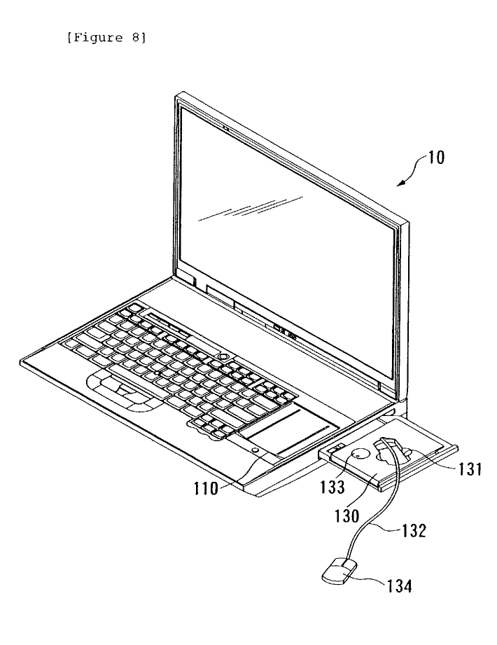

In FIG. 8, a mouse cradle (function-expanding pad) 130 is connected to the tray 40 of the notebook PC 10. The mouse cradle 130 is provided with a mouse 134 serving as a pointing device, a cord (signal-transmitting portion) 132 for connecting the mouse 134, a cord-winding portion (reel) 133 for winding the cord 132 around it, and a holding portion 131 for housing the mouse 134. Moreover, the mouse cradle 130 connects with the USB-connecting terminal 41 in the tray 40 through a not-illustrated USB-connecting terminal.

At the time of using the mouse 134 as a pointing device, the tray 40 is taken out from the side face of the body portion 14 as shown in FIG. 8. Then, the mouse 134 is taken out from the holding portion 131 and the cord 132 is extended from the cord-winding portion 133 to use the mouse 134. Moreover, when there is not any space for using the mouse 134, the cord 132 is wound by rotating the cord-winding portion 133 in a predetermined direction to house the mouse 134 in the holding portion 131. Furthermore, it is possible to bring the notebook PC 10 into the state shown in FIG. 2 by housing the tray 40 in the PC 10.

Therefore, the mouse 134 can be used when a user wants to use the mouse 134 and there is a space in which the mouse 134 can be used. However, when there is not any space to use the mouse 134 or it is unnecessary to use the mouse 134, the mouse 134 can be housed in the body portion 14 of the notebook PC 10. Therefore, a space to be wastefully used is not easily produced when the notebook PC 10 is operated or housed.

As described above, in the case of the above embodiment, the notebook PC 10 has two places where a function-expanding pad can be connected. Therefore, it is possible to easily expand functions of the notebook PC 10 by connecting a plurality of types of function-expanding pads in accordance with a request of a user. Moreover, it is possible to easily remove a connected function-expanding pad from the notebook PC 10. Furthermore, because the tray 40 of the notebook PC 10 can be housed in the body portion 14, it is allowed to house an unnecessary device in the body portion 14 without removing it from the tray 40.

Moreover, it is possible to use a fingerprint certification pad provided with a sensor, a scanner pad capable of capturing an image, and a mouse pad provided with a track ball as function-expanding pads. Furthermore, function-expanding pads to be connected to the accepting portion 30 and tray 40 are not restricted to input devices. For example, it is possible to use a pad provided with a digital camera, a pad provided with an MP3 player, a pad provided with a removable portable telephone, a pad for connecting a portable telephone, and a pad provided with a mixer and a loudspeaker.

The above-described function-expanding pads such as the expansive ten-key pad 100, PDA cradle pad 110, touch-panel pad 120, and mouse cradle 130 are respectively provided with a USB-connecting terminal and therefore, each of them can be connected to a USB-connecting cable. Therefore, it is possible to use these function-expanding pads at portions other than the accepting portion 30 and tray 40 of the notebook PC 10. For example, it is possible to connect the pads to a not-illustrated USB connective portion set at the outside (back side) of the body portion 14 of the notebook PC 10. Moreover, it is possible to use the pads by connecting them to the USB connective portion of the body of a desk-top PC. Therefore, when a user obtains one desired function-expanding pad, the user does not have to obtain another device having the same function. It is also possible to connect the above function-expanding pads to a keyboard connected to a desk-top PC.

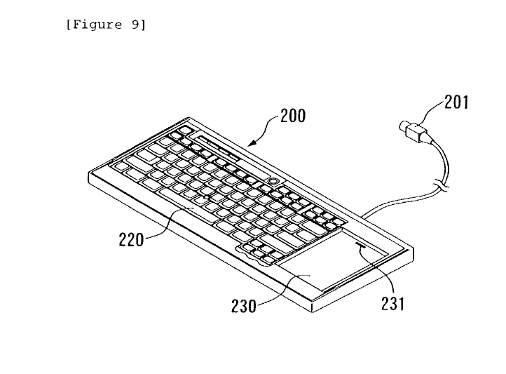

The keyboard 200 shown in FIG. 9 is an input device which can be used by connecting it to a desk-top PC (not illustrated). The keyboard 200 is provided with a plurality of keys 220 arranged to input alphabetical characters and a function-expanding-pad accepting portion 230 having a USB-connecting terminal 231 just next to the keys 220. Moreover, the keyboard 200 is provided with a USB-connecting connector 201 extending from the back of the keyboard 200.

The accepting portion 230 of the keyboard 200 has the same configuration as the accepting portion 30 of the notebook PC 10, to which function-expanding pads such as the expansive ten-key pad 100, PDA cradle pad 110, and touch-panel pad 120 can be connected in accordance with a user's request. Therefore, a user can customize the keyboard 200 in accordance with his taste. Moreover, by introducing a function-expanding pad required by a user, it is possible to prevent a space produced by setting an unnecessary device from wasting. Furthermore, when a user having the keyboard 200 further owns the notebook PC 10, it is possible to use a function-expanding pad for the keyboard 200 and notebook PC 10. Therefore, the user does not have to obtain a device having the same function for every unit, that is, a user does not have to separately obtain devices to be connected to the keyboard 200 and notebook PC 10.

In the case of the above embodiment, connection with a function-expanding pad is performed through USB connection. Therefore, it is possible to connect function-expanding pads of various types of functions and supply power. However, a connection method is not restricted to a USB.

Moreover, it is possible to adopt or reject the configuration used for the above embodiment or properly change the configuration to other configurations without departing from the spirit and scope of the present invention.

What is claimed is:

1) A computer system including a housing to or from which a plurality of function-expanding pads can be set or removed,
wherein said housing comprises:
an input portion provided with keys for inputting characters;
a mounting portion capable of removably mounting the function-expanding pads adjacently to the input portion; and
a tray to be taken out from the housing and capable of removably mounting the function-expanding pads.

2) The computer system according to claim 1, wherein said tray has an interface connected with the function-expanding pads set in the tray to transceive signals.

3) The computer system according to claim 1, wherein the mounting portion and the tray can flexibly mount a plurality of types of function-expanding pads having a common connective portion.

4) A computer system whose functions are expanded by connecting with function-expanding pads, comprising:
a plurality of mounting portions capable of mounting the function-expanding pads constituted by input devices for inputting data to a system; and
a connective portion set to each of the mounting portions to make it possible to transfer data to and from a system by mounting the function-expanding pads.

5) The computer system according to claim 4,
wherein at least one of the mounting portions is a tray to be taken out from the computer system so that it can be used, and
the tray can be housed in the computer system while mounting the function-expanding pads.

6) The computer system according to claim 4, wherein at least one of the mounting portions is set to a position facing a user when the computer system is operated.

7) A computer system having a housing portion capable of connecting function-expanding pads, comprising:
a function-expanding-pad tray protruding from a side portion of the housing portion in a transverse direction and capable of housing the function-expanding pads; and
an interface for transferring data to and from the function-expanding pads at contact faces with the function-expanding pads mounted in the tray,
wherein the tray can be housed in the housing portion while mounting the function-expanding pads.

8) The computer system according to claim 7, wherein
the interface is connected by a USB.

9) A computer system provided with a mouse, comprising:
a housing provided with a system;
a tray which can be taken out from the housing;
a mouse to be housed in the tray; and
a signal-transmitting portion for transmitting a signal generated by the mouse taken out of the tray to the system.

10) The computer system according to claim 9,
wherein said signal-transmitting portion is a cord for connecting the tray with the mouse, and
the tray is provided with a cord-housing portion for housing the cord.

11) A computer system whose functions can be expanded by connecting function-expanding pads, comprising:
a housing provided with a system; and
a function-expanding-pad-connecting unit housed in the housing to connect with the system,
wherein the function-expanding-pad-connecting unit includes:
a tray for removably mounting the function-expanding pads; and
a case for holding the tray so that the tray can be taken out from the housing.

12) The computer system according to claim 11, wherein the function-expanding-pad-connecting unit can be housed in the case while the tray mounts the function-expanding pads.

13) A function-expanding pad constituted so that it can be connected with a computer system and capable of expanding functions of the computer system, comprising:
a body portion which can be mounted on a mounting portion set to the computer system and a tray set to the computer system so that the tray can be taken out; and
a connective portion formed on the mounting portion or a face contacting the tray to transmit a signal that can be input to the computer system.

14) The function-expanding pad according to claim 13, wherein the function-expanding pad functions as an expansive ten-key pad, a PDA cradle pad, a mouse cradle, or a touch-panel pad.

15) A mouse cradle which can be connected to a computer system, comprising:
a housing portion for housing a mouse;
a cord extending from the mouse; and
a reel for winding the cord around the reel.

16) The mouse cradle according to claim 15, wherein the mouse housed in the housing portion can be housed in the computer system.

17) A function-expanding-pad-connecting unit housed in a body portion of a computer system to connect with function-expanding pads, comprising:
a tray capable of removably mounting the function-expanding pads; and
a case for holding the tray so as to be taken out.

18) The function-expanding-pad-connecting unit according to claim 17,
wherein said computer system is a notebook computer system, and
the function-expanding pads are housed in a side portion of the body portion of the notebook computer system.
